(19) United States
(12) Patent Application Publication
(10) Pub. No.: US 2026/0081386 A1
(43) Pub. Date: Mar. 19, 2026

(54) ETHERNET BOX COUPLER

(71) Applicant: Nokomis, Inc., Canonsburg, PA (US)

(72) Inventors: Walter J. Keller, III, Bridgeville, PA (US); VINCENT FENG, PITTSBURGH, PA (US); TODD ERIC CHORNENKY, CARMICHAELS, PA (US)

(73) Assignee: Nokomis, Inc., Canonsburg, PA (US)

(21) Appl. No.: 19/327,273

(22) Filed: Sep. 12, 2025

Related U.S. Application Data
(60) Provisional application No. 63/695,475, filed on Sep. 17, 2024.

(51) Int. Cl. H01R 13/6463; H01R 13/6591; H01R 13/66; H01R 24/64

(52) U.S. Cl. CPC H01R 13/6463; H01R 13/65915; H01R 13/6658; H01R 24/64

(57) ABSTRACT

An apparatus configured to acquire unintended emissions from a conductor passed through an opening in a toroid and electrically and mechanically connected to at least one connector. The apparatus includes an enclosure for RF shielding or physical protection of the ether. An RF connector is electrically and mechanically connected to ends of the toroid winding to carry a voltage from the electromagnetic field generated at the core. Connectors facilitate easy and secure connections with electrical devices and RF analysis equipment.

### CROSS-REFERENCE TO RELATED APPLICATIONS

This nonprovisional application claims the benefit of priority, under 35 U.S.C. sctn. 119(e), to a U.S. Provisional Patent Application Ser. No. 63/695,475 filed on Sep. 17, 2024, and titled “ETHERNET COUPLER BOX”, which is hereby incorporated by reference in its entirety.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### Technical Field

The subject matter relates, in general, to an apparatus and a method to capture an emission of an electromagnetic energy in a radio frequency (RF) spectrum from a conductor of electrical current. The subject matter may relate to an apparatus and a method to acquire an emission of an electromagnetic energy in a radio frequency (RF) spectrum from a conductor such as an interconnect cable. The subject matter may relate to an apparatus and a method to acquire unintended emissions from a conductor such as an interconnect cable The subject matter may relate to detecting cyber-attacks, hacking attempts, software Trojan implant attempts, aging and/or degradation in electrical and/or electronic devices connected to the conductor. The subject matter may further relate to an apparatus with an enclosure being configured with electrical signal connectors and being further configured to electronically shield and host at least the conductor within a toroid to determine characteristics of devices connected to the interconnect cable and/or conductor or characteristics of signals carried through such conductor.

### BRIEF DESCRIPTION OF THE DRAWINGS

The accompanying drawings are incorporated in and constitute part of the specification and illustrate various embodiments. In the drawings:

FIGS. 1A-1B illustrate a (toroid) ring core that may be used as a coupling transformer;

FIG. 2 illustrates a perspective view of an apparatus configured to capture emissions from a conductor of an electrical current (illustrated as an ethernet cable) using the ring core shown in FIG. 1;

FIG. 3 illustrates a perspective view of a housing designed to shield and contain the apparatus shown in FIG. 2;

FIGS. 4A-4C illustrate perspective views of the apparatus of FIGS. 1-3;

FIG. 5 illustrates a perspective view of a 4-port apparatus configured to capture emissions from a conductor of an electrical current;

FIG. 6 illustrates a perspective view of the apparatus of FIG. 5;

FIG. 7 illustrates a perspective view of a 2-port apparatus configured to capture emissions from a conductor of an electrical current;

FIG. 8 illustrates a illustrates a perspective view of a 2-port apparatus configured to capture emissions from a conductor of an electrical current;

FIG. 9 illustrates a illustrates a perspective view of an apparatus configured to capture emissions from a conductor of an electrical current;

FIG. 10 illustrates a illustrates a perspective view of an apparatus configured to capture emissions from a conductor of an electrical current;

FIG. 11 illustrates a illustrates a perspective view of an apparatus configured to capture emissions from a conductor of an electrical current;

FIG. 12 illustrates a illustrates a perspective view of an apparatus configured to capture emissions from a conductor of an electrical current;

FIG. 13 illustrates a illustrates a perspective view of an apparatus configured to capture emissions from a conductor of an electrical current;

FIG. 14 illustrates a illustrates a perspective view of an apparatus configured to capture emissions from a conductor of an electrical current;

FIG. 15 illustrates a illustrates a perspective view of an apparatus configured to capture emissions from a conductor of an electrical current; and

FIG. 16 illustrates a illustrates a perspective view of an apparatus configured to capture emissions from a conductor of an electrical current.

### DETAILED DESCRIPTION

Prior to proceeding to the more detailed description of the present subject matter, it should be noted that, for the sake of clarity and understanding, identical components which have identical functions have been identified with identical reference numerals throughout the several views illustrated in the drawing figures.

Features which are described in the context of separate embodiments may also be provided in combination in a single embodiment. Conversely, various features which are, for brevity, described in the context of a single embodiment, may also be provided separately or in any suitable sub-combination. The Applicant hereby gives notice that new Claims may be formulated to such features and/or combinations of such features during the prosecution of the present Application or of any further Application derived therefrom.

It is to be understood that the singular forms “a,” “an,” and “the” include plural referents unless the context clearly dictates otherwise or expressly specified otherwise. Thus, for example, reference to “a component surface” includes reference to one or more of such surfaces.

For purposes here, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either. or,” “only one of,” or similar language; or (ii) two or more of the listed alternatives are mutually exclusive within the particular context, in which case “or” would encompass only those combinations involving non-mutually-exclusive alternatives.

For purposes here, the words “comprising,” “including,” “having,” and variants thereof, wherever they appear, shall be construed as open-ended terminology, with the same meaning as if the phrase “at least” were appended after each instance thereof.

The verb “may” is used to designate optionality/noncompulsoriness. In other words, something that “may”can, but need not.

Before elucidating the subject matter shown in the Figures, the present disclosure will be first described in general terms.

An electrically operable (electrical, electromechanical or the electronic) device produces and radiates an emission in an electromagnetic spectrum when powered. The electrically operable device may be a device of an electronic type. This device may be an integrated circuit (IC). This device may be a semiconductor device. The electrically operable device may be an electrical device. This device may be microprocessor based controller. This device may be a programmable logic controller (PLC). This device may be a computer. This device may be an Ethernet hub. This device may be an Ethernet switch. This device may be a transformer. This device may be a motor. This device may be an assembly of electronic and/or electrical components. The electrically operable may be an electromechanical device. This device may be servo motor. This device may be an actuator.

When the electrically operable device is powered, a current flow through internal circuitry, and the inherent acceleration and deceleration of electrons, results in spontaneous emissions that are dependent upon path length, geometry, and the electrical properties of the components and material compositions used in the internal circuitry (reactance, resistivity, etc.).

As such, a powered electrically operable device generates at least one emission. Such at least one emission may be referred to as an unintended emission since the device is only powered and not commanded to perform intended operations.

When the electrically operable device is powered and is commanded to perform a function, such at least one emission may be referred to as an intended emission in a response to an intended function being performed.

Such intended and/or unintended at least one emission may be conducted through cabling attached or interfaced to the electrically operable device. The cabling may be commonly used ethernet cabling.

The emission may be an emission in a radio frequency (RF) range of the electromagnetic spectrum. This emission may be referred to as an RF emission. The RF emission may be in a frequency range from 1 KHz to 300 GHz. The emission may be a millimeter wave emission.

The specific emission produced by the electrically operable device is unique to at least one of a circuitry, a functionality, a status, and a condition of the electrically operable device. As such, the specific emission may be considered a signature or a fingerprint of an electrical or electronic device to which one or more cables may be attached, providing at least one feature or characteristic and, preferably, metrics of features (characteristics).

The emission may be considered a signature or a fingerprint of at least one communication between the electrically powered devices to which the communication cables are attached. Communication may include transmission of data between the electrical or electronic devices. Thus, the communication cable may be referred to as a conductor.

The signature may include a waveform. In other words, the signature may be referred to as a signature waveform. The emission signature may generally include at least one fundamental property, including, but not being limited to, a magnitude, a frequency location, a feature structure, phase noise parameters, an integrated emission energy, an emitted energy state distribution, harmonic relationships, and non-linear mixing product parameters.

The signature may include a plurality of waveforms in a time domain. The signature may include a portion of a spectrum at a specific (specified) frequency in a frequency domain. The signature may include a portion of a spectrum at a specific (specified) bandwidth in a frequency domain. The signature may include a portion of a spectrum at a specific (specified) resolution bandwidth (RBW) in a frequency domain.

It may be desirable to capture the at least one emission from a communication and/or a data transmission from at least one electrically operable device and process at least one signature characteristic. The at least one signature characteristic may be leveraged to assess a condition of the electrically operable device. The condition may be a health of the electrically operable device. The condition may be a remaining useful life (RUL) of the electrically operable device. The condition may be an aging of the electrically operable device.

An apparatus configured to capture at least one emission in a radio frequency (RF) range of an electromagnetic spectrum may be designed with a conductor of electrical current (current-carrying conductor) and a toroid having a through opening sized to pass the conductor therethrough.

The conductor may be provided as at least one wire. The conductor may be manufactured from a copper material. The conductor may be manufactured from an aluminum material. The conductor may be manufactured from a copper-clad aluminum material. The conductor may be provided as a single strand (solid). The conductor may be provided as multiple strands (stranded). The at least one wire may be an unshielded wire. The at least one wire may be a wire enclosed into a shield, i.e. a shielded wire. The at least one wire may be a wire enclosed with insulation, i.e. an insulated wire. The at least one wire may be provided to transmit (carry) current therethrough. The at least one wire may be provided to transmit a communication (signal) therethrough. This at least one wire may be referred to as a communication cable. The at least one wire may be provided to transmit a data (signal) therethrough. This at least one wire may be referred to as a conductor.

The conductor may be a data transmission cable. The data transmission cable may include two unshielded wires twisted together, i.e. a twisted pair. The two wires twisted together may be referred to as a pair of twisted wires. The conductor may include more than two unshielded twisted pairs. The conductor may include four unshielded twisted pair conductor wirings. The conductor may include an ethernet cable. A conductor of a twisted pair type may be used for local area networks (LANs), routers or switches.

The conductor may be a coaxial cable. The coaxial cable type may be used for cable television, broadband, and radio frequency (RF) transmissions. The conductor may be a universal serial bus (USB) cable. The USB cable type may be used for peripheral devices. The conductor may be a serial type cable. The serial cable type may be used for industrial controls. The conductor may be a high-definition multimedia interface (HDMI) cable. The HDMI cable type may be used for to transmit video and audio between devices.

The conductor may be provided as a power conductor. This power conductor may be used in branch circuits. The conductor may be provided as a signal conductor. This signal conductor may be used in signal systems. The conductor may be provided as a flexible cord. This flexible cord may be used to connect an appliance to an electrical grid. This flexible cord may be used to connect an equipment to an electrical grid. This flexible cord may be also referred to as a power cord. The conductor may be provided as a fixture wire.

The conductor may be provided (designed, configured, adapted) as a trace or a pathway on a surface of a substrate of a printed circuit board (PCB). The conductor may be provided within a layer of a multi-layered PCB and be separated by another layer from a direct contact with the surface of the board (substrate). The conductor may be provided as two or more (a plurality of) printed traces on the board. The conductor may be provided as two or more (a plurality of) traces within a layer of a multi-layered PCB and be separated by another layer from a direct contact with the surface of the board. In a multi-layer PCB, traces are printed using a photolithographic and etching process—layer by layer. Thus, when the board is laminated into a single unit, the trace or traces may be disposed within a thickness of the PCB.

The conductor may be provided (designed, configured, adapted) as a bus bar, is a metallic strip or bar used in electrical systems to distribute power efficiently across multiple circuits or components. The conductor may be provided (designed, configured, adapted) as a laminated bus bar that may be a multi-layered conductor assembly made of copper or aluminum sheets separated by thin dielectric insulation.

The toroid may be provided as a core with a through opening and with a winding. The core may be manufactured from a ferrite material. A composition mix (compound) of the ferrite material core may be selected for a specific frequency of a frequency range of a signal transmitted through the cable. A composition mix #31 (MnZn) may be selected for a frequency band between about 1 kilohertz (KHz) and about 10 megahertz (MHz). A composition mix #31 may be selected for a frequency band between about 1 MHz and about 60 MHz. The composition mix #31 may be used in broad-spectrum noise suppression. A composition mix #43 (NiZn) may be selected for a frequency band between about 10 MHz and about 250 MHz. A composition mix #43 (NiZn) may be selected for a frequency band between about 10 MHz and about 1 gigahertz (GHz). A composition mix of Fair-Rite 68 Material may meet requirements of permeability variation and resonance frequency range. A composition mix #61 (NiZn) may be selected for a frequency band between about 20 KHz and about 100 KHz.

The core may be manufactured from a powdered iron. Material of the core may be selected to accommodate ethernet signaling rates faster than the present standards. Material of the core may be selected to accommodate different bus speeds. Material of the core may be selected to accommodate different electrically operable devices connected to the conductor. The core may include a coating when the conductor includes unshielded wires. The core may include an insulation when the conductor includes at least one unshielded wire. The core may include a coating when the conductor includes at least one shielded wire. The wire selected may be #26 enameled wire as a balance between size and performance. As an example, the toroid core may be manufactured by Fair-Rite Products Corp. as model 968000301 or model 5968001101.

The through opening may have a round shape. This core may be referred to as a ring core. The through opening may have an oval shape. In either shape, the through opening is sized to pass the conductor therethrough. A portion of the peripheral surface of the opening may contact the conductor. In other words, the conductor may support the toroid, thus eliminating a need to mechanically attach the toroid to a structure. The through opening may be sized and shaped to pass a PCB with one or more traces (pathways). The through opening may be sized and shaped to pass a flexible PCB with one or more traces. The flexible PCB may enable and easy insertion into a rigid enclosure such as a conductive metal rectangular enclosure containing apertures to accommodate connectors. The flexible PCB may also enable the insertion of the PCB and associated connectors through the opening of a ferrite toroid core for easier assembly. This may also be used in conjunction with the rigid enclosure, as described above. The through opening may be sized and shaped to pass the conductor connector therethrough.

The winding may cage a portion of the core. The winding may include one complete loop (turn) of wire. The winding may include one complete loop (turn) of a single wire. The toroid may be provided with one and only one complete loop of a single electrical wire. The toroid may be provided with two and only two complete loops of a single electrical wire. The winding may include a length of shieled electrical wire. The winding may include a length of unshielded electrical wire. A greater number of loops may generate a higher inductance. A greater number of loops may reduce a high frequency response. High frequency may be in a range from about 3 MHZ to about 30 MHz. High frequency may be greater than 30 MHz. The core of the toroid may be in a magnetic field connection with the conductor in a response to a current flow through the conductor.

The core may be provided as a continuous or endless core of one piece. The core may be provided as a split core. The core may be provided as two halves that may be mechanically attached to each other with an adhesive. This core may have two visual splits where the two halves meet. The two halves may be mechanically attached therebetween after the device is assembled or as a snap-on capability in a similar manner as a clamp-on ammeter.

One half may be manufactured from a ferrite material while the other half may be manufactured from metal for ease of magnetic attachment to each other.

The two halves may be attached to each other with an adhesive. The adhesive may be a one-component epoxy. The one-component epoxy may be easy to dispense and cure quickly with heat. The one-component epoxy may provide a high bond strength and good thermal stability. The one-component epoxy may include glass spacer beads to control gap spacing. The adhesive may be a two-component epoxy. The two-component epoxy may offer flexibility in formulation and curing profiles. The two-component epoxy may be useful for coil encapsulation and structural bonding. The adhesive may be a UV-cured adhesive. The UV-cured adhesive may cure in seconds under UV light. The adhesive may be a structural acrylic. The structural acrylic may be associated with fast curing.

The toroid may include a core designed with two halves and with a hinged connection and a snap-in connection. The core may be designed with two halves and a case configured to receive the two halves, the case being further configured with each of a hinged connection and a snap connection. This toroid may be manufactured by Fair-Rite Products Corp. under a “clip-it Core” and/or Snap-it. TM product line(s) with either round or oval through opening.

The core may be configured with at least two portions of different sizes. The core may be configured with more than two portions.

An apparatus configured to capture at least one emission in a radio frequency (RF) range of an electromagnetic spectrum may be designed with a conductor connector, a conductor, as described above, a toroid, as described above, and a radio frequency (RF) connector.

The conductor connector may be a male RJ-45 connector. The conductor connector may be a female RJ-45 connector. The conductor connector may be a fiberoptic connector. The conductor connector may be a coaxial connector. The conductor connector may be an audio/video connector. The conductor transmits a current from the conductor connector, being an input connector. The conductor connector connects electrical load to the conductor.

The conductor may have one end thereof in an electrical signal connection and in a mechanical connection with the conductor connector.

The RF connector may be any one of a subminiature version A (SMA), a subminiature version (SMB), a subminiature push-on (SMP), a bayonet neill-councelman (BNC), and an N-Type.

The RF connector may have a center pin in an electrical signal connection with one end of the winding of the toroid and having a shield in an electrical signal connection with another end of the winding, the center pin carrying a voltage induced across the winding. The RF connector functions as an output connector.

The conductor may have an opposite end thereof in an electrical signal connection and in a mechanical connection with another conductor connector. The conductor may have an opposite end thereof in an electrical signal connection and in a mechanical connection with at least one resistor.

The two conductor connectors may be of a same type. These two conductor connectors may be male type connectors. These two conductor connectors may be female type connectors. The two conductor connectors may be of different types with one (first) conductor connector being a male connector and the other (second) conductor connector being a female connector.

The apparatus may further include an enclosure in mechanical connections with one or more conductor connectors and the RF connector and be designed with a peripheral wall defining a hollow interior being shaped and sized to receive the toroid with at least one wire (conductor) therewithin. The enclosure may be manufactured from (or include) an electrically conductive metallic material and may be referred to as a metallic enclosure. The enclosure may include a lid (cover) to completely shield the hollow interior after assembly of the connectors, conductor and the toroid. The lid may be in a permanent rigid connection with the peripheral wall. The lid may be welded to the peripheral wall after assembly of the above components. The lid may be in a detachable connection with the peripheral wall.

The peripheral wall includes two or more apertures so that each connector may be in a mechanical connection with the peripheral wall and having a portion being at least accessible from the hollow interior.

The core may be configured to capture an emission of electromagnetic energy from a conductor of an ethernet cable type and provide it to an external analysis unit such as a spectrum analyzer. The apparatus may further comprise a coaxial connector such as an SMA connector. The apparatus may further comprise one or more ethernet connectors connected to one or both ends of the ethernet cable. The apparatus may further comprise a winding around said core. The apparatus may further comprise a connection of the winding to an SMA connector.

The apparatus may be designed with an enclosure having a hollow interior configured to receive an ethernet cable, a core, a winding around a core, and connectors. The enclosure may comprise a conductive material to act as an RF Shield shielding the ethernet cable, core, the winding, and possible connections to connectors attached to the enclosure. In other words, the enclosure may be designed as an electrically conductive enclosure. The enclosure may be provided as an electrically grounded enclosure. A portion of the peripheral wall may define a lid (cover) to completely shield the hollow interior from an exterior environment. The lid may be fastened to a remaining portion of the peripheral wall. The lid may be welded to the remaining portion of the peripheral wall. The lid may be mechanically connected to the remaining portion of the peripheral wall with an adhesive.

The enclosure may be provided as an extrusion or as a tubular shape with ends closed after insertion of at least the toroid and the conductor. A conductor connector may be mechanically connected to one end of the enclosure either before or after electrical signal connection with the conductor.

When the apparatus includes a PCB within the hollow interior, such PCB may be mechanically fastened to the interior surface of the enclosure. When the apparatus includes a PCB within the hollow interior and having connectors soldered to the PCB, such PCB may be held in place by way of mechanical connections of the connectors with the peripheral wall.

An apparatus configured to capture at least one emission in a radio frequency (RF) range of an electromagnetic spectrum may be designed with a conductor connector, as described above, in electrical and mechanical connections with one end of a conductor, as described above, a toroid, as described above, a radio frequency (RF) connector, as described above, in electrical and mechanical connections with ends of a winding, and conductors and resisters connected to an opposite end of the conductor.

An apparatus configured to capture at least one emission in a radio frequency (RF) range of an electromagnetic spectrum may be designed with an enclosure, as described above, two conductor connectors, as described above, a conductor, as described above, a toroid, as described above, and RF connector, as described above.

The enclosure may have a peripheral wall defining a hollow interior. One (first) connector from the two connectors may be a male conductor connector being in a mechanical connection with the enclosure at a first aperture in a first portion of the peripheral wall. The other (second) connector from the two connectors may be a female conductor connector being in a mechanical connection with the enclosure at a second aperture in a second portion of the peripheral wall. For the sake of clarity, the conductor being disposed within the hollow interior and being in a first electrical signal connection at a first end thereof with one (first) conductor connector from male and female conductor connectors and being in a second electrical signal connection and in a second mechanical connection, at an opposite second end thereof, with another (second)conductor connector from the male and female conductor connectors. An RF connector being provided in a mechanical connection with the enclosure at a third aperture in a third portion of the peripheral wall, the RF connector being in a first electrical signal connection and in a first mechanical connection with one end of the winding and being in a second electrical signal connection and in a second mechanical connection with another end of the winding.

The apparatus may capture the at least one emission of the electromagnetic energy in the RF spectrum range from the conductor with the electromagnetic energy being generated within a magnetic field in the winding in a response to an electrical current flow through the conductor, and output a voltage available at the RF connector, the voltage induced across the winding, the voltage containing a signature of the at least one emission. The material of the core may be selected so that the apparatus is operable to capture the at least one emission with a frequency of at least 30 MHz.

The conductor connectors may be selected as ethernet connectors connected to one or both ends of the ethernet cable disposed within the enclosure. The RF connector may be selected as an SMA connector.

The toroid may be provided as a balun transformer.

An apparatus configured to capture at least one emission in a radio frequency (RF) range of an electromagnetic spectrum may be only designed with an enclosure, as described above, two conductor connectors, as described above, a conductor, as described above, a toroid, as described above, and RF connector, as described above.

An apparatus configured to capture at least one emission in a radio frequency (RF) range of an electromagnetic spectrum may be designed with an enclosure, four conductor connectors, as described above, two conductors, as described above, two toroids, as described above, and two RF connectors, as described above.

The enclosure may at least include a peripheral wall defining a hollow interior of the enclosure and a partition within the hollow interior of the enclosure, the partition defining two hollow interior portions, the partition having an aperture through a thickness thereof. The four conductor connectors may be in mechanical connections with at least one portion of the peripheral wall.

Each conductor from the two conductors may be in a first electrical signal connection at a first end thereof with one conductor connector from a respective pair of conductor connectors and being in a second electrical signal connection and in a second mechanical connection, at an opposite second end thereof, with another conductor connector from the respective pair of conductor connectors.

Each toroid from two toroids may be disposed within a respective hollow interior portion, the each toroid including a core with a through opening encasing a respective conductor and a winding around the core, the winding of one toroid being passed through the aperture in the partition

Each RF connector from the two RF connectors may be being in with a respective winding and in an electrical signal connection and in a mechanical connection with the enclosure at a plurality of second apertures in a third wall portion of the enclosure.

The following data buses and/or data connectors are also, but not limited to being envisioned as candidates to be implemented in the apparatus: IEEE 1284, ARINC 429, ARINC 629, MIL-STD-1553B (STANAG 3838), and EFABus (STANAG 3910), PCIe or PCI, Asus Media Bus, Computer Automated Measurement and Control (CAMAC), ISA or EISA, LPC, MBus, MicroChannel or MCA, Multibus, NuBus or IEEE 1196, Parallel ATA (also known as Advanced Technology Attachment, ATA, PATA, IDE, EIDE, ATAPI, etc.), S-100 bus or IEEE 696, SBus or IEEE 1496, SS-50 Bus, STEbus, STD Bus (for STD-80 [8-bit] and STD32 [16-/32-bit]), Unibus, Q-Bus, VESA Local Bus or VLB or VL-bus, VMEbus, the VERSAmodule Eurocard bus, PC/104, PC/104-Plus, PCI/104-Express, 1-Wire, HyperTransport, I²C, I3C (bus), SLIMbus, PCI Express or PCIe, Serial ATA (SATA), Hard disk drive, solid-state drive, optical disc drive, tape drive peripheral attachment bus, Serial Peripheral Interface (SPI) bus, UNI/O, SMBus, Advanced eXtensible Interface, M-PHY, HIPPI High Performance Parallel Interface, IEEE-488 (also known as GPIB, General-Purpose Interface Bus, and HPIB, Hewlett-Packard Instrumentation Bus), PC Card, previously known as PCMCIA, RS-485, CAN bus (“Controller Area Network”), Modbus, ARINC 429, MIL-STD-1553, IEEE 1355, Camera Link, eSATA, ExpressCard, IEEE 1394 interface (FireWire), RS-232, Thunderbolt, and universal data bus (USB).

An apparatus configured to capture at least one emission in a radio frequency (RF) range of an electromagnetic spectrum may be designed with a conductor, as described above, two conductor connectors, as described above, a toroid, as described above, RF connector, as described above, and a printed circuit board (PCB).

The conductor may be provided as one or more pathways or traces on the PCB substrate. One or both conductor connectors may be in a direct mechanical connection with the substrate and in an electrical signal connection with the conductor. The electrical signal connection may be by way of soldering. One or both conductor connectors may be in an indirect mechanical connection with the substrate and in an indirect electrical signal connection with the conductor by way of additional conductor(s), for example such as twisted pairs. In view of the above, the through opening in the core may be sized and shaped to receive the PCB substrate therethrough.

The PCB substrate may be designed with two through apertures to pass the core therethrough that may be of a split design with two halves. The PCB substrate may be designed with one through aperture and one cutout in one edge of the substrate to pass the core therethrough that may be of a split design with two halves. The PCB substrate may be designed with two cutouts in two opposite edges to pass the core therethrough that may be of a split design with two halves.

The ends of the winding in the PCB design may be in direct electrical signal connection with the RF connector. The ends of the winding in the PCB design may be in an indirect electrical signal connection with the RF connector by way of additional traces.

An apparatus configured to capture at least one emission in a radio frequency (RF) range of an electromagnetic spectrum may be designed with an enclosure, a plurality of ethernet connectors, as described above, a plurality of ethernet cables, as described above, a plurality of toroids, as described above, and a plurality of RF connectors, as described above.

The enclosure may at least include a plurality of partitions within a hollow interior of the enclosure, the plurality of partitions defining a plurality of hollow interior portions.

Each toroid from the plurality of toroids may be disposed within a respective hollow interior portion, some windings being passed through at least one aperture in the plurality of partitions;

Each ethernet cable from the plurality of ethernet cables may be passed through a respective ferromagnetic core within the respective hollow interior portion.

The plurality of the ethernet connectors may be in mechanical connections with the enclosure at a plurality of first apertures in first and second wall portion of the enclosure, a pair of conductor connectors from the plurality of conductor connectors being in electrical signal connections with opposite ends of a respective ethernet cable

The plurality of RF connectors may be in mechanical connections with the enclosure at a plurality of second apertures in a third wall portion of the enclosure, each RF connector from the plurality of RF connectors may be in an electrical signal connect with a respective winding.

The apparatus, as described above, may be configured with an additional optional ferrite core, being disposed between a toroid and a conductor connector and passing the conductor through an opening thereof, to filter noise. This optional ferrite core may be used as low-pass filter. This optional ferrite core may be used as a filter to suppress a high-frequency noise. This optional ferrite core may be used as a filter to allow low-frequency signals. This optional ferrite core may be used as a filter to dissipate unwanted energy as heat within the ferrite material.

A suitable means of isolating the emissions from 1 of the 2 devices connected to the apparatus may be include incorporation of a low pass filter on one end of the apparatus. The low pass filter may be comprised of an Emi ferrite bead, an Emi filter chip, an EMI ferrite suppression core, an inductor, a low pass filter circuit, or other similar means.

An apparatus configured to capture at least one emission in a radio frequency (RF) range of an electromagnetic spectrum may be only designed with an enclosure, as described above, two conductor connectors, as described above, a conductor, as described above, a toroid, as described above, an RF connector, as described above, and an additional ferrite core, as described above.

An apparatus configured to capture at least one emission in a radio frequency (RF) range of an electromagnetic spectrum may be only designed with an enclosure, as described above, two conductor connectors, as described above, a conductor, as described above, a toroid, as described above, and RF connector, as described above.

An analyzer configured to analyze the signature of at least one emission captured by the apparatus emission may be electrically and mechanically connected to the RF connector. The emission signature analyzer may be directly connected to the apparatus by way of a mating RF connector configured to electrically and mechanically connect to the RF connector of the apparatus. The emission signature analyzer may be indirectly connected to the apparatus by way of a cable disposed in electrical and mechanical connections with the RF connector of the apparatus and in electrical and mechanical connections with the RF connector of the signature analyzer. The emission signature analyzer may be first connected to the cable before a connection of the cable and RF connector is made. The cable may be first connected to the RF connector and then to the emission signature analyzer.

The emission signature analyzer may be referred to as any one of an emission analyzer, a signature analyzer, an analyzer, an RF emission signature analyzer, an RF signature analyzer, an RF emission analyzer, an RF analyzer, A RF Spectrum Analyzer, and an IR analyzer. The emission signature analyzer may comprise a receiver configured to receive the RF emission from the RF connector and convert the RF emission into a digital form, and a control unit configured to process the signature of the emission in the digital form.

The control unit may comprise one or more processors and a non-transitory memory (storage medium) having executable instructions stored thereon that when executed by the processor cause the processor to perform operations comprising at least identifying non-linear products (NPLs) within the signature, and comparing identified NPLs with the baseline NPLs. The control unit may comprise a real-time spectrum analyzer (RISA).

The executable instructions may include at least one of Harmonic Analysis, Matched Filter, non-harmonic correlation, timing correlation, Artificial Neural Networks (ANN), specifically multilayer perception (MLP) feed-forward ANN with back propagation (BP), Wavelet Decomposition, Autocorrelation, Spectral Feature Measurements or Statistics, Clustering or Phase Detrending algorithms.

The control unit may be referred to as a processing device.

The operations may further comprise determining aging of a component connected to the ethernet cable or radiating emissions into the ethernet cable based on a comparison between identified NPLS and baseline NPLs.

The operations may further comprise calculating a remaining useful life (RUL) of a component-based on a comparison between identified NPLs and baseline NPLs. RUL may define a stress level condition of the electrical device.

The operations may further comprise assessing a health of a component connected to the ethernet cable or radiating emissions into the ethernet cable based on a comparison between identified NPLS and baseline NPLs. Health may be related to performance of the component at the time of assessment. Health may manifest as a degradation of the component. Health may manifest as a remaining useful life of the component.

DSP integrated circuit(s) (IC) and a single board computer may also be provided in any apparatus, as described above. There may be also a computational medium comprising algorithms and/or executable instructions that, when executed by the one or more processors or logic devices, cause the one or more processors or logic devices to perform, in one exemplary embodiment, the following steps on the captured unintended emitted electromagnetic energy and/or the unintended conducted energy: measuring a feature value in at least one spectral frequency region of the captured unintended emitted electromagnetic energy and/or unintended conducted energy from the electrical component, calculating a difference value between the measured feature value and a baseline feature value, and determining, based on the calculated difference value, a condition or a status of the electrical component.

A logic set analysis of RF emissions received may include at least one of Harmonic Analysis, Matched Filter, non-harmonic correlation, timing correlation, Artificial Neural Networks (ANN), specifically multilayer perception (MLP) feed-forward ANN with back propagation (BP), Wavelet Decomposition, Autocorrelation, Spectral Feature Measurements or Statistics, Clustering or Phase Detrending algorithms.

A graphic user interface (GUI) may be provided in communication with one-or both-time domain and frequency domain processing modules, for example through the connector. The GUI may include a screen. The GUI may include a display.

An optional filter may also be provided within the enclosure. The filter may be provided when strong interfering signals from the electrical, electromechanical or electronic components located adjacent to the electrical component or ethernet cable must be compensated for.

The receiver may be designed with a high sensitivity of at least −150 dBm. This design may be achieved by using a low noise amplifier (LNA) with a power gain of about 20 decibels (dB) and a noise figure lower than about 1.0. An analog-to-digital converter (ADC) may be used in a combination with the LNA. The ADC may be a 16-bit ADC. A filter may be mounted in a circuit before the LNA, where the signal from the RF connector will be first filtered through the filter prior to input into LNA. The filter may comprise a bandpass filter. The filter may comprise a highpass filter. The filter may be a lowpass filter. The filter may comprise a selectable filter bank. The selectable filter bank may be connected in a signal path between the LNA and the ADC. The selectable filter bank may be connected in a signal path between ADC and emission signal processing. The selectable filter bank may comprise an array of band-pass filters, the selectable filter bank separates the frequency signal in the analog form into components, each component carrying a single frequency sub-band of the frequency signal in the analog form.

This emission signature analyzer may be designed to analyze RF emissions levels that are substantially below the radiated emissions, as governed by the above-described standards, and provide health assessment of a component or components.

The operations may further comprise assessing the existence or modification of software or Hardware operating within the components attached to the ethernet cable. It may also assess the removal or addition of components connected to the ethernet cable.

The emission signature analyzer may measure bandwidths of at least 1Khz at a frequency resolution of at least 1 Hz. The emission signature analyzer may tune to a frequency or select a frequency between 10 Mhz and 3 Ghz. The emission signature analyzer may measure bandwidths of 1 Mhz or more at a frequency resolution range of 1 Hz, 0.1 Hz, 0.01 Hz, 10 Hz, 100 Hz, and/or 1 khz. A Fourier Transform, for example such as a Discrete Furrier Transform (DFT) or a Fast Furrier Transform (FFT) may be used to process the incoming RF emission signal from the RF connector to provide this frequency resolution result. Electromagnetic signature elements and signature region 2-D patterns for comparison purposes may be extracted across a wide frequency band via quantitative analysis. Such signature elements for quantitative analysis may include averaged or statistical quantities representing measurements including the noise floor level, phase noise distribution, absolute and relative peak locations to other peaks, non-linear product peak envelope shape, and the structure of identified peaks.

The emission signature analyzer may be designed as a wideband RF measurement diagnostic device comprised of a sensor apparatus that includes at least one RF connector, a low noise amplifier and a radio frequency collection apparatus, an analog to digital converter to convert analog waveforms into digital format, a control unit with a digital signal processing capability and software comprised of algorithms which may be used to detect anomalies in the received spectrum of RF emissions to detect any one of aging, degradation and remaining useful life (RUL) in automotive electrical components. The control unit may comprise a search engine that automatically searches the collected spectrum for patterns of non-linear mixing product (NPLs) in the collected emission signature. The measured NPLs may be compared with NPLs of previously acquired measurements when the vehicle emissions or an exemplary vehicle's emissions was measured at an earlier time.

The control unit may be configured to use characteristics, such as any one of correlation of harmonics in the received RF spectrum, a dB vs. frequency pattern of specific RF emission location changes, the frequency location and/or dB correlation of non-harmonically related peaks in the received spectrum to make assessments about the connected electronic devices' electrical components.

A characteristic, such as frequency vs. dB pattern or voltage vs. time may be discerned from the captured emissions data of at least one of in a time domain form or in a frequency domain form.

The control unit may measure a change in a signal strength or field strength it operates to detect the degradation anomaly and even determine the location of a degraded emission source. The detectable anomalies may include a semiconductor degradation, a degradation in bonding of the semiconductor to leads in a part, and a degradation in the circuit board that the electronic devices are connected to as well the interconnects between board and individual electronic modules that are interconnected in modern electronic equipment. The cause of the degradation can be aging or low levels of arcing due to electrostatic discharge.

The emission signature analyzer may be configured to exploit subtle, yet distinctly characteristic fingerprint-like patterns of unintended RF emissions to detect anomalous electrical component. The apparatus may have a plurality of RF emission acquisition and processing channels which act independently, facilitating the ability to analyze signature indicators simultaneously in different spectral regions. A multi-channel apparatus enables simultaneous assessment of emissions data in multiple frequency regions providing a more rapid and powerful breakthrough capability in the battle against bad parts. The apparatus may comprise two or more channels. The apparatus may comprise four channels.

The emission signature analyzer may be configured to acquire multiple measurements from multiple occurrences, to determine a pattern of RF emission change indicating an estimated duration before the electrical component fails.

This emission signature analyzer may be configured as an ultra-sensitive RF emission sensor system that not only captures low level emissions only a few dB above the theoretical thermal noise floor of-174dBm at 1 Hz RBW, but also resolves very fine characteristic frequency features, thus offering the capability of presenting more than sufficient separate data points for subsequent analysis. The very fine frequency resolution may extend to 1/100 Hz RBW and be presented in bins in a software algorithm at resolution of anywhere from 10 Hz to 1/100 Hz.

A complementary software and algorithms associated with the hardware may be capable of discerning differences between complex features buried deep within the acquired electromagnetic spectrum on a real-time basis.

The apparatus may be configured to also contain a low noise amplifier. The apparatus may be configured to also contain at least one of a high pass filter, a low pass filter, a bandpass filter, and a band reject filter. The apparatus may be configured to also contain an RF processing and analysis device which processes the received emissions. Such an RF processing and Analysis device may be connected to a data cable and or connector the passage digital result signal outside the enclosure.

In view of the above, a method may comprise capturing, with a ferrite core and a winding, both disposed internal to an enclosure (i.e. within a hollow interior thereof), at least one emission of electromagnetic energy in a RF range from an information from a component connected to the ethernet cable, with the emission being carried by the ethernet cable, with an analyzer coupled to the RF connector, a signature of the emission; and determining a condition of the component based on a processed signature of the emission.

In view of the above, a method may include steps of capturing, with a toroid having a ferrite core with a through opening and a winding disposed around the core and an ethernet cable passed through the through opening and being electrically and mechanically connected to at least one conductor connector, at least one emission of electromagnetic energy in a radio frequency (RF) range from at least one device being electrically operable and being connected to the at least one conductor connector, the electromagnetic energy being generated in a response to a current flow, through the ethernet cable, from the at least one device; then analyzing (processing), with an analyzer coupled to an output connector, a signature of the at least one RF emission, the signature contained within an RF connector electrically and mechanically coupled to ends of the winding; and determining (computing, measuring) a condition of the device based on a processed signature of the at least one emission.

In view of the above, a method may include steps of electrically and mechanically connecting a data bus coupler to one or more devices being electrically operable and to a signature analyzer; capturing, with a toroid and an ethernet cable disposed within a hollow interior of a metallic enclosure of the data bus coupler, the toroid having a core with a through opening and a winding disposed around the core and the ethernet cable being passed through the through opening and being electrically and mechanically connected to at least one conductor connector being in a mechanical connection with the metallic enclosure, at least one emission of electromagnetic energy in a radio frequency (RF) range from at least one device being connected to the at least one conductor connector, the electromagnetic energy being generated in a response to a current flow, through the ethernet cable, from the at least one device; processing, with the signature analyzer coupled to an RF connector being in electrical and mechanical connections with ends of the winding and being in a mechanical connection with the enclosure, a signature of the at least one RF emission, the signature contained within a voltage extracted by the signature analyzer from the RF connector; and determining (measuring, computing) a condition of the at least one device based on a processed signature of the at least one emission.

In view of the above, a method may include steps of electrically and mechanically connecting a conductor with a balun transformer to two conductor connectors; electrically and mechanically connecting ends of a winding in a balun transformer to a radio frequency (RF) connector; electrically and mechanically connecting one electrically operable device to one conductor connector from the two conductor connectors; electrically and mechanically connecting another electrically operable device to another conductor connector from the two conductor connectors; electrically and mechanically connecting a signature analyzer to the RF connector; enabling a communication through the conductor in a response to electrically operating at least one of two electrically operable devices, the communication containing a flow of an alternative current (AC); and generating a magnetic field within the balun transformer in a response to the flow.

In view of the above, a method may include steps of electrically and mechanically connecting a conductor with a balun transformer to two conductor connectors; electrically and mechanically connecting ends of a winding in a balun transformer to a radio frequency (RF) connector; electrically and mechanically connecting one electrically operable device to one conductor connector from the two conductor connectors; electrically and mechanically connecting another electrically operable device to another conductor connector from the two conductor connectors; electrically and mechanically connecting a signature analyzer to the RF connector; enabling a communication through the conductor in a response to electrically operating at least one of two electrically operable devices, the communication containing a flow of an alternative current (AC); generating a magnetic field within the balun transformer in a response to the flow; extracting, with the signature analyzer, a voltage available at the RF connector in a response to a magnetic field generation; extracting, with the signature analyzer, at least one analog characteristic contained within the voltage; measuring, with the signature analyzer, the at least one analog characteristic; and determining at least a condition of the communication based on measured at least one analog characteristic.

Processing of the RF emission may comprise a correlation of harmonics in a signature of a captured emission. Processing of the emission may comprise comparing amplitude versus frequency pattern in a signature of a captured emission. Processing of the RF emission may comprise analyzing frequency locations of non-harmonically related peaks in a signature of a captured emission. Processing of the RF emission may comprise analyzing amplitudes of non-harmonically related peaks in a signature of a captured emission. Processing of the RF emission may comprise measuring a change in a signal strength as the component performs varied tasks.

Processing of the RF emission may comprise a correlation of harmonics in a signature of a captured RF emission. Processing of the RF emission may comprise comparing amplitude versus frequency pattern in a signature of a captured RF emission. Processing of the RF emission may comprise analyzing frequency locations of non-harmonically related peaks in a signature of a captured RF emission. Processing of the RF emission may comprise analyzing amplitudes of non-harmonically related peaks in a signature of a captured RF emission. Processing of the RF emission may comprise measuring a change in a signal strength as the component moves while connected to an ethernet cable.

The method, as described above, may further comprise determining a location of degraded RF emission source in a component in a response to a measured change.

The method, as described above, may further comprise using past RF emissions data from different apparatus locations along the same or different ethernet cables to detect a rate of degradation or a change from previously acquired RF emissions data.

The method, as described above, may further comprise using past RF emissions data from different component of same make and model to form an average of expected signatures of RF emissions representing component aging to determine a degree of deviation from a baseline, and determine one of a ranking, a threshold, and a calculation made based on a percentile of the deviation.

The method, as described above, may further comprise isolating the component on its own ethernet bus to acquire exemplary emissions for comparison purposes.

The above apparatus and method may be implemented as a computer program executing on a machine, as a computer program product, or as a tangible and/or non-transitory computer-readable medium having stored instructions.

Tangible computer readable medium means any physical object or computer element that can store and/or execute computer instructions. Examples of tangible computer readable medium include, but not limited to, a compact disc (CD), digital versatile disc (DVD), blu-ray disc (BD), USB, floppy drive, floppy disk, random access memory (RAM), read-only memory (ROM), erasable programmable read-only memory (EPROM), optical fiber, etc. It should be noted that the tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

The disclosed method may be implemented in the form of software stored on a computer-readable non-transitory information storage medium such as an optical or magnetic disk, a non-volatile memory (e.g., Flash or ROM), RAM, and other forms of volatile memory. The information storage medium may be an internal part of the computer, a removable external element coupled to the computer, or unit that is remotely accessible via a wired or wireless network.

Program code for carrying out operations for aspects of various embodiments may be written in any combination of one or more programming languages, including an object-oriented programming language, such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As electrical devices, especially microelectronics become more prevalent, with advanced or complex components, the apparatus and the method, as described above, identify, in a non-intrusive and in a real-time manner and through evaluation of changes to the unintended RF emissions of the components and interconnects of associated subsystems, any one of aging, reliability, remaining capability of the component, potential threats and vulnerabilities.

The analysis and evaluation of these RF emissions may provide an accurate determination of both the health state of the device, thereby predicting probability of fault, as well as providing a prediction of the RUL of the component or the subsystem under test. The ability to diagnose and predict the RUL of the electrical component(s) or subsystems within the component and enable more accurate testing and more rapid testing, as well as new predictive regimens of maintenance.

The apparatus and/or method, as described above, may potentially provide significant future cost savings for owners in the proactive maintenance of equipment, by identifying and/or predicting RUL.

The apparatus and/or method, as described above, may potentially improve design of the component through emissions being captured and analyzed during testing in the research and development phase of the component to identify an electrical component with a less than desired operating life.

In view of the above, the described apparatus may utilize the causal relationship between the internal circuitry of an electrical or electromechanical component, part, subsystem or system and its unintended emission signature and uses this predetermined relationship to identify aged components, monitor electronic health, detect counterfeits, and detect degradation related to component, part, subsystem or system integrity.

The apparatus may be configured and/or used to assess aging of selected, or any connected component electronics by exploiting unintended electromagnetic emissions from electronic and microelectronic devices that are integrated into and critical for the operation of modern components. Emission exploitation may be a reliable and immutable method to identify electronic devices based on their fundamental electronic activity.

The apparatus may be operable to monitor, detect and/or differentiate between common mode emissions arising from the ethernet cable.

The apparatus and/or method, as described above, may be used to determine RUL of selected, or any connected electrical component by comparing processed emission signature against a signature profile that has been obtained for the electrical component at different stages of the life cycle of such electrical component.

The apparatus and/or method, as described above, may be used to determine a stress condition or a stress level of selected, or any connected electrical component by comparing processed emission signature against a signature profile that may have been obtained for the electrical component at different voltage levels or at different power levels.

The apparatus may be completely non-invasive and requiring very simple test parameters.

In an embodiment, a signature analyzer such as a Real Time Spectrum Analyzer, Swept Spectrum Analyzer, or oscilloscope may be used with the apparatus to process the measurement.

Now in reference to Figures:

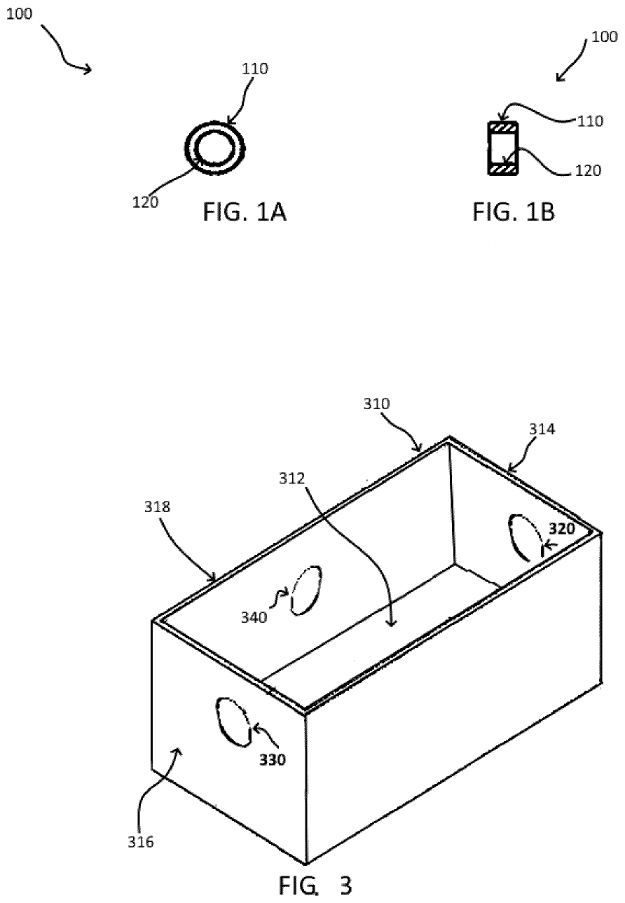

FIGS. 1A-1B illustrate elevation view and a cross-sectional view of a toroid 100 with a core 110 with a through opening 120 that is illustrated as a round opening.

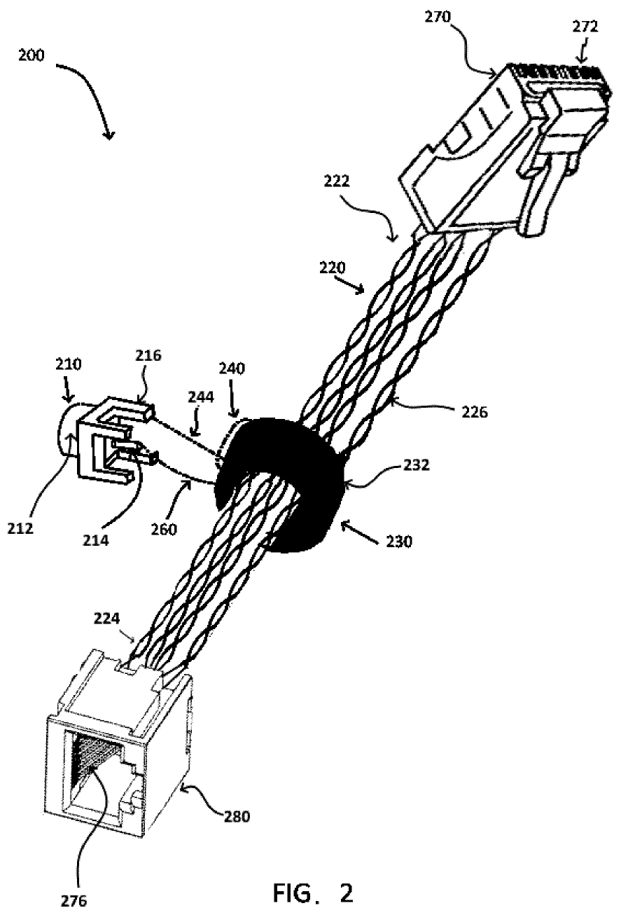

FIG. 2 illustrates an apparatus 200 configured to capture at least one emission in a radio frequency (RF) range of an electromagnetic spectrum. The apparatus 200 is illustrated with a radio frequency (RF) connector 210, a conductor 220, a toroid 230, a male conductor connector 270 and a female conductor connector 280.

The RF connector 210 is illustrated as a coaxial connector with an interface portion 212, a center pin 214 and a shield pin 216. The RF connector 210 functions as an output connector and may be referred to as an output port.

The conductor 220 is illustrated with four twisted pairs 226 and with ends 222 and 224.

One end of the conductor 220, illustrated as end 222, is in electrical and mechanical connections with a male conductor connector 270, illustrated as a male registered jack (RJ)-45 connector with pins 272. Opposite end of the conductor 220, illustrated as an end 224, is in electrical and mechanical connections with a female conductor connector 280, illustrated as a female RJ-45 connector with pins 276. The male conductor connector 270 and the female conductor connector 280 may be of different types.

The toroid 230 includes a core 232. The core 232 may be the core 110 of FIG. 1. The core 232 is shown as encircling a portion of the conductor 220 that passes through an opening of the core 232. The winding 240 around the core 232 is in electromagnetic field connection with the core 232 and thus induces RF composite emissions from the conductor 220. The winding 240 is illustrated with one wire end 260 being in an electrical signal connection with the center pin 214 and with another wire end 244 being in an electrical signal connection with the shield 216. The RF connector 210 may be a SMA, SMB, SMC, N-Type, BNC, TNC, or other type connector.

The apparatus 200 of FIG. 2 may be only configured with one conductor connector. The apparatus 200 of FIG. 2 may be configured with conductor connectors of the same type, either male or female.

FIG. 3 illustrates an exemplary enclosure 300 adapted (capable, designed, configured) to at least partially contain the apparatus 200 of FIG. 2.

The enclosure 300 is illustrated with the peripheral wall 310 partially open to expose a hollow interior 312. The hollow interior 312 is sized to receive the conductor 220 and the toroid 230.

A first aperture 320 is illustrated in a first portion 314 of the peripheral wall 310 to mechanically attach one conductor connector from the male conductor connector 270 and female conductor connector 280.

A second aperture 330 is illustrated in a second portion 316 of the peripheral wall 310 to mechanically attach the other conductor connector from the male conductor connector 270 and female conductor connector 280.

A third aperture 340 is illustrated in a third portion 318 of the peripheral wall 310 to mechanically attach the RF connector 210.

An optional cover is not illustrated but may be provided to substantially completely enclose the hollow interior 312 except for apertures 32 , 330, and 340.

The enclosure 300 may be manufactured from a conductive material and the shield of the RF connector may be connected to the conductive enclosure 300. The enclosure 300 is seen without a cover for illustration purposes but would be constructed with a conductive cover in a mechanical and an electrical contact with the enclosure 300 creating an enclosed volume. The enclosure 300, made from a conductive material, may be adapted to be connected to a ground source such as the RF shield of the RF connector 210.

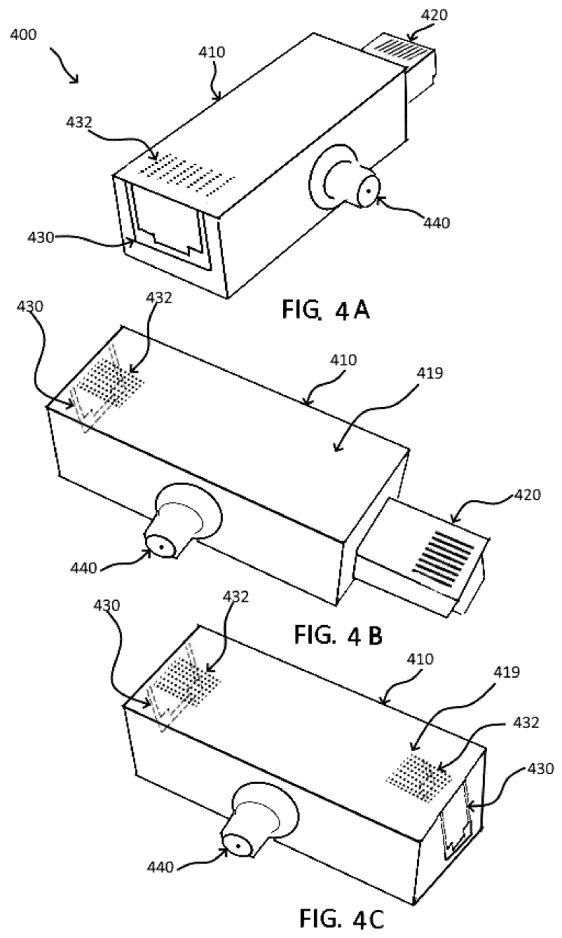

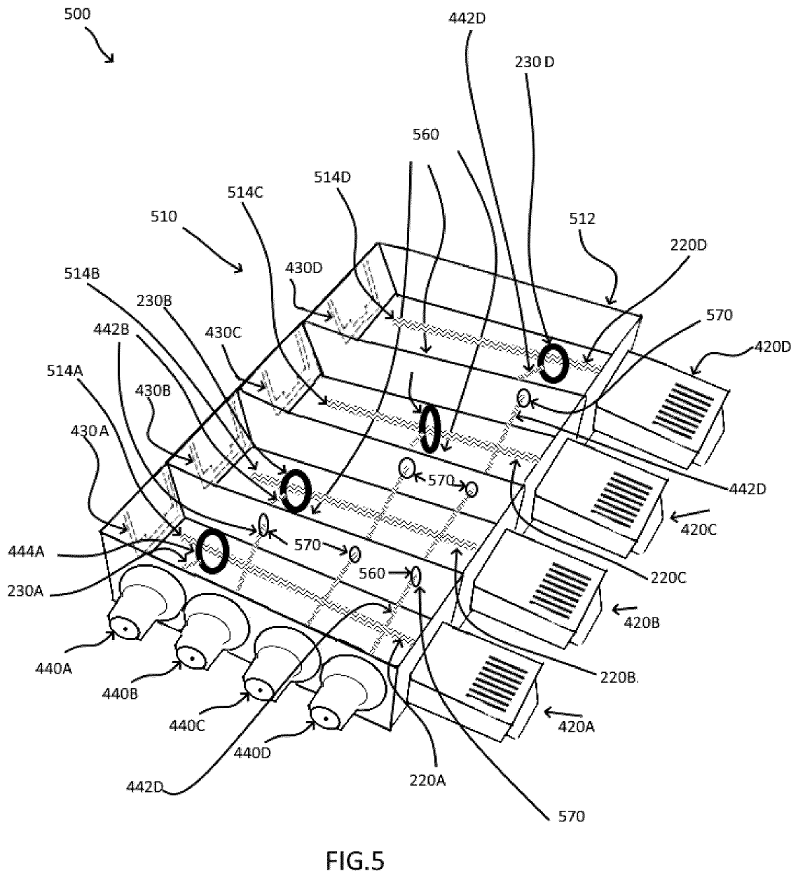

FIGS. 4A-4B illustrate an exemplary apparatus 400 with an enclosure 410 and the apparatus 200, being illustrated by the conductor connectors 420, 430 and RF connector 440. The outside RF shield within the RF connector 440 provides a ground which is electrically connected to the conductive enclosure 300 to electromagnetically shield the enclosed electronics.

The enclosure 400 may be the enclosure 300, as discussed above, and is illustrated with an SMA connector 440 on the opposite side, on top, and/or on the bottom to more easily facilitate hosting multiple coaxial connection to corresponding multiple SMA connectors 440 for ethernet cables on separate multiple enclosures 400 in a densely packed arrangement without physical interference with each other, causing a reduction of physical interference thus enabling a more densely packed arrangement.

The enclosure 410 may be manufactured from an electrically conductive material and capable of acting as an RF shield connected to at least one of the RF or SMA connector 440 Shield. The enclosure 410 is also illustrated as including a male RJ-45 connector 420 and a female RJ-45 connector 430. These would be connected to the cable ends 222 and 224, as is best illustrated in FIG. 2. It is also envisioned that multiple SMA connectors 440, multiple male RJ-45s connector 420, and/or multiple female RJ-45 connector 430 may be attached to the enclosure 410 and may offer emissions from the same ethernet cable 220 for use by multiple RF analyzer or processor inputs or devices' separate or coordinated analysis of emissions of conductor cable 220. This may be done by including multiple separate winding 240 around the toroid 230 around and/or multiple toroids with associated windings along the same ethernet cable 220 or by including a device such as an RF splitter or RF Tee inside enclosure 410. Alternatively, multiple toroids 230 may each be located around the multiple ethernet cables 220, each toroid may have a winding 240 for output to one or more SMA connector 440. In this way multiple emissions from multiple ethernet cables 220 may be captured by construction to combine into a single SMA connector 440 for the analysis of several ethernet cable 220 emissions simultaneously.

It is envisioned that if multiple ethernet cables 220 are contained within a single enclosure 410, an electrically conductive shield wall connected to a conductive enclosure 410 may be present to shield each cable 220 from each other. It is envisioned that if multiple ethernet cables 220 may be contained within a single enclosure 410, each would have corresponding conductor connectors 420 and 430. This is more specifically illustrated in FIG. 5.

A rationale for using two or more separate RF connectors 440 connecting to different RF analysis devices may be for redundancy purposes, to allow multiple independent agencies to all host their own separate RF emission processing and security monitoring to satisfy security requirements without involving the others, or to allow for uninterrupted monitoring of ethernet emissions by at least one RF emissions processing system while the other is offline due to performing a software enhancement update or RF emissions signature file(s) update.

FIG. 5 illustrates an exemplary apparatus 500 with an exemplary 4-port enclosure 510, which is shown without its top conductive protective RF shield cover removed for illustration clarity. The enclosure 510 may be designed as the enclosure 410, as described above, except being configured for a plurality of conductors, toroids, and connectors.

Accordingly, the enclosure 510 is configured with a plurality of 3 partitions 560 connecting opposite interior surface of the peripheral wall 512 and defining four hollow interior portions or compartments 514A, 514B, 514C and 514D. Conductors 220A, 220B, 220C and 220D are illustrated as disposed within respective hollow interior portions 514A, 514B, 514C and 514D. Less than four conductors may be provided even if the enclosure 510 is designed with four hollow interior portions.

Male conductor connectors are illustrated as male RJ-45 connectors 420A, 420B, 420C, and 420D. Female conductor connectors are illustrated as female RJ-45 connectors 430A, 430B, 430C, and 430D respectively.

The emissions from conductors 220A, 220B, 220C and 220D are captured by toroids 230A, 230B, 230C and 230D and outputted by RF connectors 440A, 440B 440C, and 440D respectively.

Wall partitions 560, which may be conductive, may be employed to separate RF emissions from each cable from each other. The partition 560 may be designed with one or more apertures 570. The aperture 570 is sized and shaped to pass the conductor therethrough. The partitions 560 are illustrated with ends being at least in a contact with an interior surface of the peripheral wall 512, although one or more partitions 560 may have a reduced length and/or being provided as two or pore portions.

Wires 442D, 442B, and 442A functioning in the same manner as wire ends 244 and 260 carry emission captured to the Rf connectors. They may pass through wall holes 570. The circuits in FIG. 5 may be the same circuit as seen in FIG. 2. In other words, each end of the cables 220A, 220B, 220C and 220D will be connected to either RJ 45 connector.

The RF connectors 440A, 440B 440C, and 440D are illustrated as attached to one wall of the enclosure 510 but may be connected to different walls.

The enclosure 510 is illustrated as containing separate hollow interior compartments, each capable of at least containing a conductor with a toroid.

The multiple port (output) enclosure 510 may be configured to be sized to exactly match the physical arrangement and separation distance between input RJ-45 ports of a 4-port, 16-port, or 8-port hub for example.

The enclosure 510 may be provided as four separate enclosures connected therebetween either detachably or permanently and incorporating the apertures 570.

It is envisioned that a multiple input and multiple output enclosure 510 may be configured to be sized to exactly match the ethernet port locations of a commercially available ethernet hub, ethernet, router, or ethernet switch so that the male RJ-45 connectors may all simultaneously plug into the female ethernet connectors of the ethernet hub. This prevents spatial interference of individual SMA connectors 440 from preventing insertion into the same ethernet hub on all ports or even two or three adjacent single enclosures 410 from side-by-side plugging into an ethernet hub, ethernet, router, or ethernet switch. This may also prevent vertical interference from multiple stacked hubs in a 19-inch rack configuration.

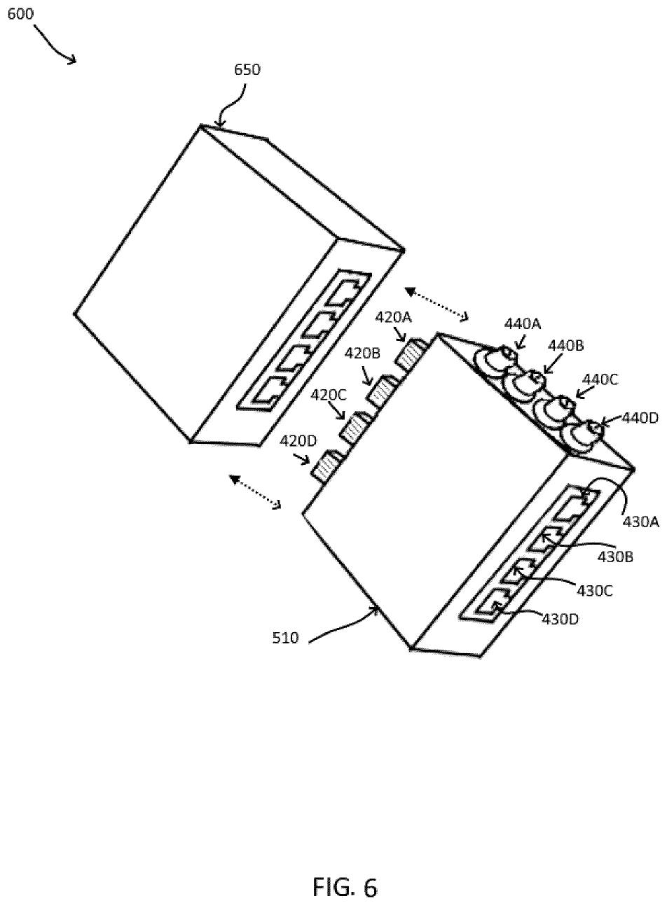

FIG. 6 illustrates an exemplary 4-port apparatus 600 with an enclosure 510 that may be sized and configured to be mechanically and electrically connected to any one of aa commercially available ethernet hub, a router, or a switch 650 while offering the RF emissions captured therein from the conductors therein via its external RF connectors 440A -440D. It may implement the circuits of FIG. 2 and design of FIG. 5.

A power-over-ethernet may also be enabled in FIG. 2, FIG. 4, FIG. 5, or FIG. 6. This may be used to power additional circuitry inside those devices.

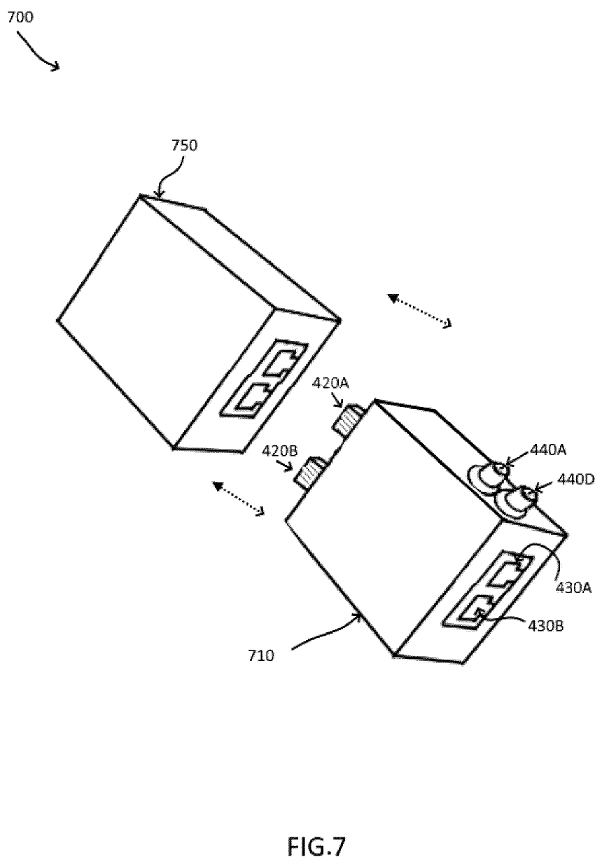

FIG. 7 illustrates an exemplary 2-port apparatus 700 with an enclosure 710 configured, in view of the above, with a single partition (not shown) separating two conductors (not shown)with toroids (not shown). Two male conductor connectors 420A and 420B, two female conductor connectors 430A and 430B and two (output) RF connectors 440A and 440B are also illustrated.

The apparatus 700 may be configured so as to mechanically and electrically connect to any one of an ethernet hub, a router, or a switch 750.

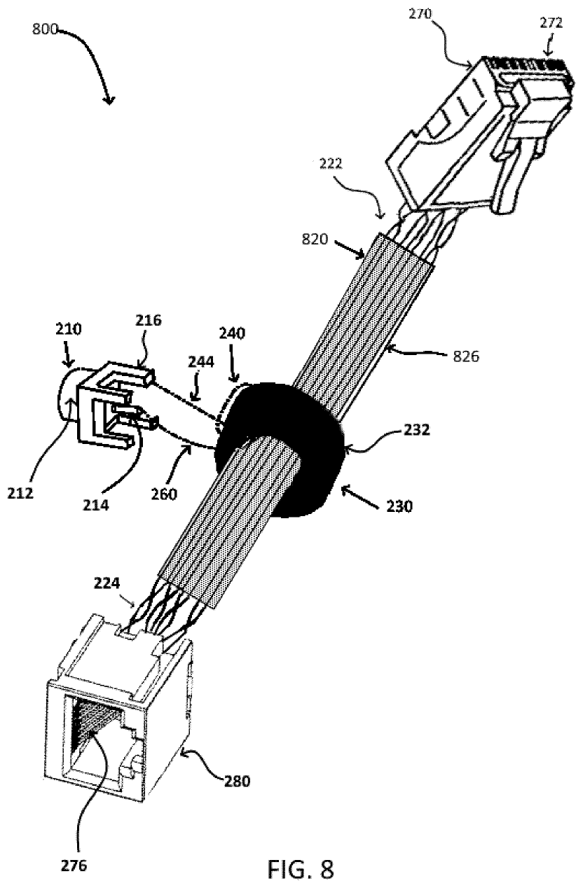

FIG. 8 illustrates a perspective view of an apparatus 800 configured to capture emissions from a conductor of an electrical current. The apparatus 800 is generally constructed as the apparatus 200 in FIG. 2, as described above, except that ends 224 and 226 of twisted pairs are in electrical and mechanical connections with conductors 826 of electrical current on a board 820. Conductors may be traces or pathways 826 may be traces printed on the board 820 and the combination may be referred to as a printed circuit board (PCB). The PCB 820 is sized to fit through the opening 120 in the core 110 or, vice versa, the opening 120 is sized and shaped to pass the PCB 820 therethrough.

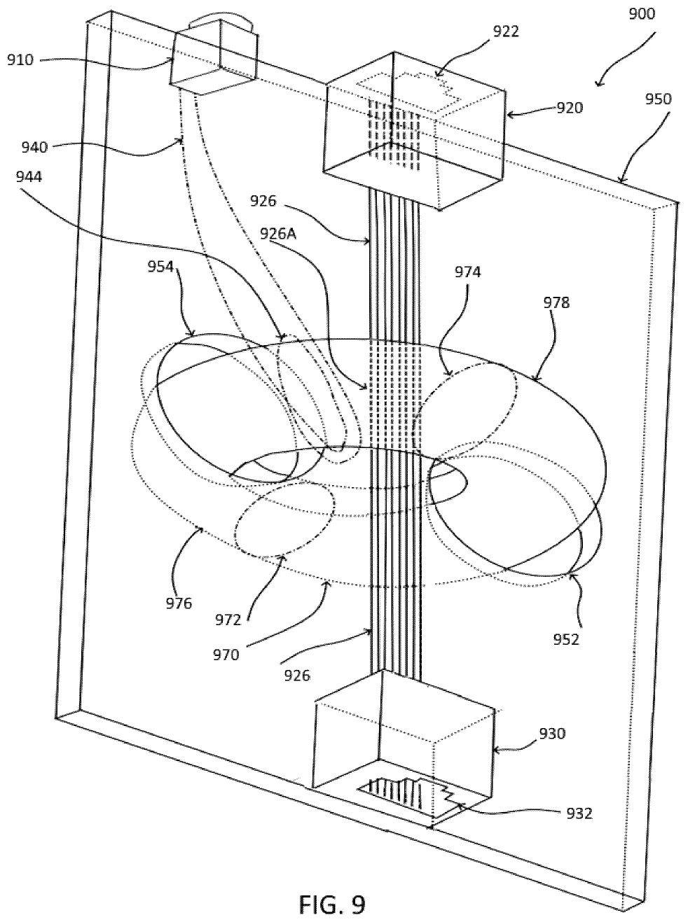

FIG. 9 illustrates a perspective view of an apparatus 900 configured to capture emissions from a conductor of an electrical current. The apparatus 900 is being further illustrated as a first female RJ-45 connector 920 with an insertion opening 922 and a second female RJ-45 connector 930 with an insertion opening 832. The connectors 920 and 930 are in electrical and mechanical connections with conductors 926 on the PCB 950. Portions 926 A of the conductors 926 are illustrated as being disposed within the ferrite core 970. A winding 944 around the core has ends 940 in electrical and mechanical connections with the RF connector 910, as described above. The RF connector 910 is illustrated as being mounted on the same edge of the PCB 950 as the first female RJ-45 connector 920 but may be mounted on any one of the remaining edges.

The ferrite core 970 is further illustrated as being designed with two halves 976 and 978 and with two splits 972 and 974. In view of the above, an adhesive (not shown) may be used to attach the two halves 976 and 978 to each other at two splits 972 and 974, as described above. The core half 978 is passed through an aperture 952 in the PCB 950 and the core half 976 is passed through an aperture 952 in the PCB 950. The splits 972 and 974 may not be needed when the PCB 950 is provided as a flexible PCB.

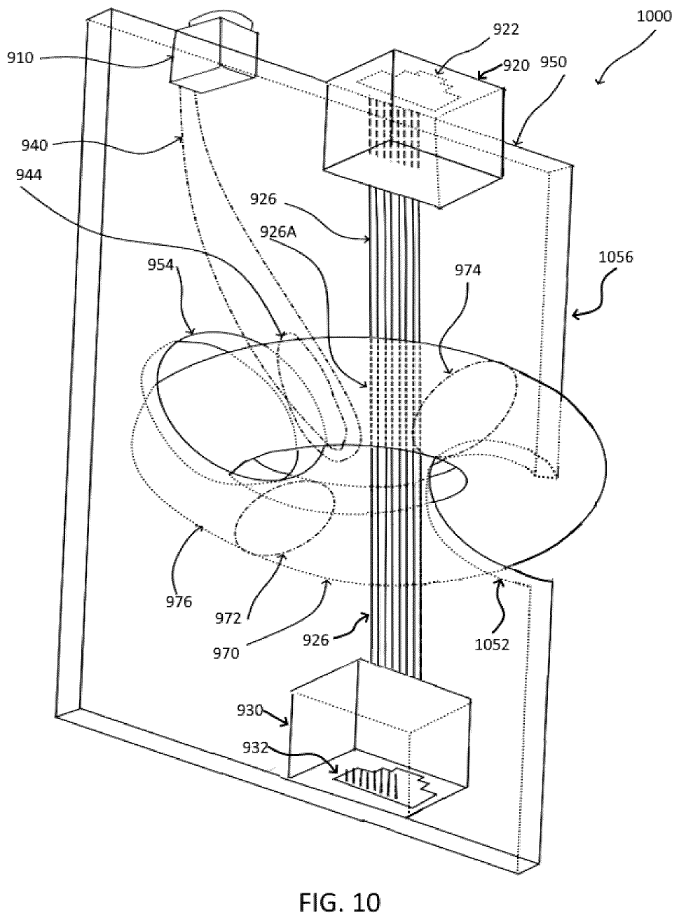

FIG. 10 illustrates a perspective view of an apparatus 1000 configured to capture emissions from a conductor of an electrical current. The apparatus 1000 is constructed essentially the same as the apparatus 900, as described above, except that the aperture 952 in FIG. 9 is replaced with a cutout 1052 in an edge 1056 of the PCB 950. The cutout 1052 is sized and shaped to receive the core half 978.

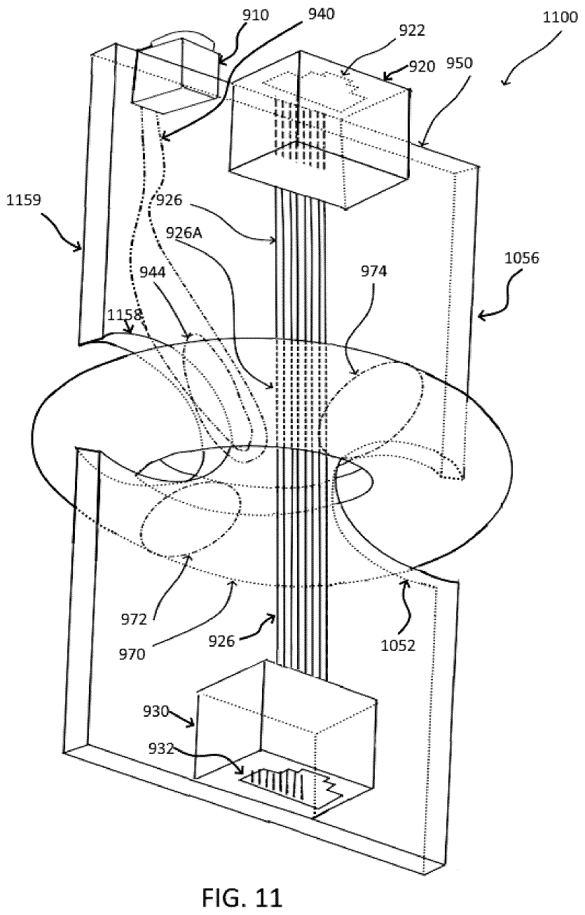

FIG. 11 illustrates a perspective view of an apparatus configured to capture emissions from a conductor of an electrical current. The apparatus 1100 is constructed essentially the same as the apparatus 1000, as described above, except that the aperture 954 in FIG. 10 is replaced with a cutout 1158 in an edge 1159 of the PCB 950. The cutout 1052 is sized and shaped to receive the core half 978. In other words, the PCB 950 is illustrated with two cutouts 1052 and 1158 in FIG. 11.

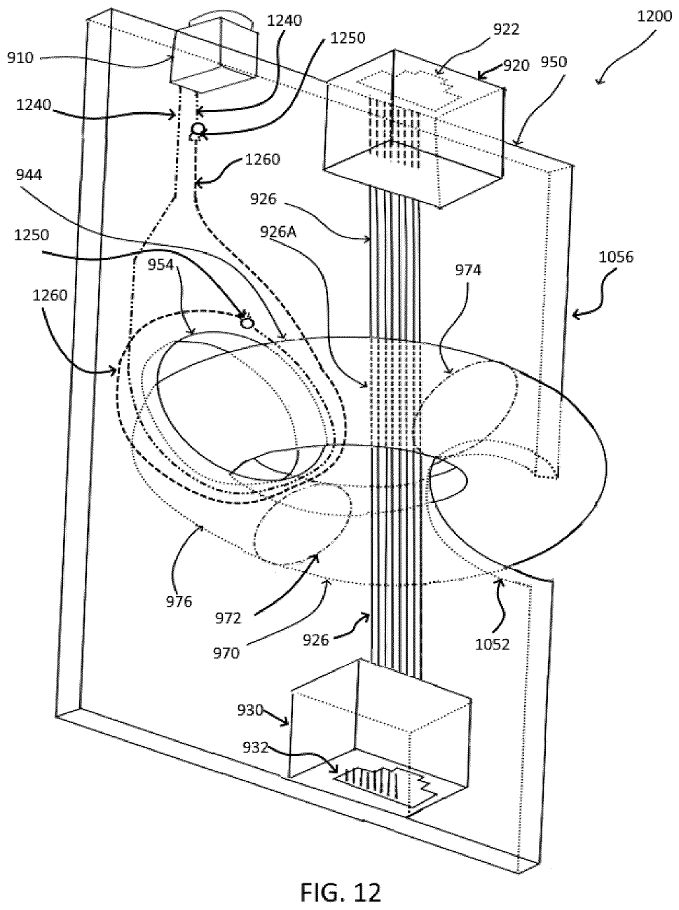

FIG. 12 illustrates a perspective view of an apparatus 1200 configured to capture emissions from a conductor of an electrical current. The apparatus 1200 is constructed essentially the same as the apparatus 900, as described above in view of FIG. 9, except for addition of PCB trace 1240 acting as RF emissions pickup coil and connected to RF connector 910, PCB via 1250 between a first layer containing a first trace 1240 and a second layer containing a second trace 1260, thereby connecting both traces together to complete the RF emissions pickup coil circuit.

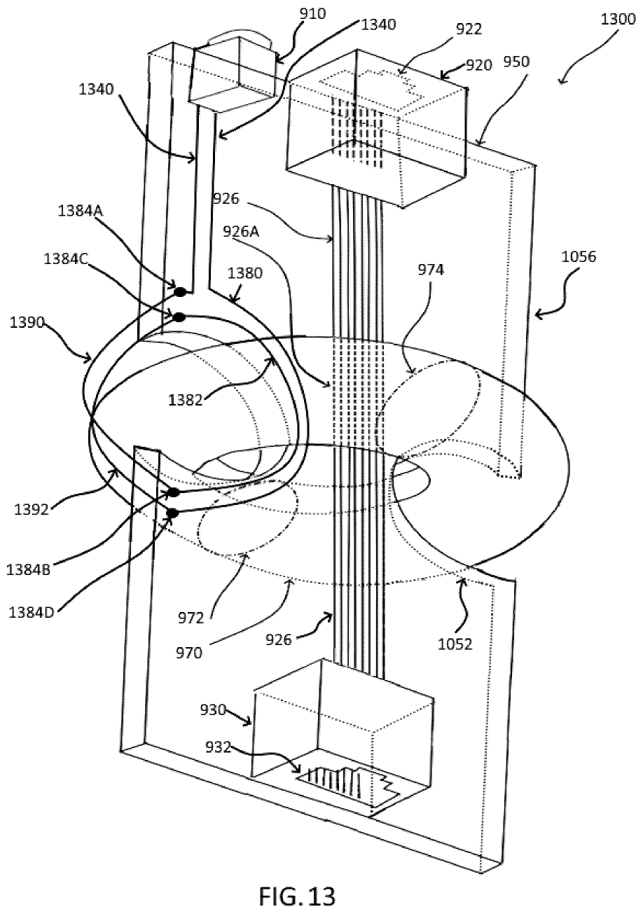

FIG. 13 illustrates a perspective view of an apparatus 1300 configured to capture emissions from a conductor of an electrical current. The apparatus 1300 is constructed essentially the same as the apparatus 1000, as described above in view of FIG. 10, except for the following design additions to allow the emissions coil circuit be completed by external wires soldered to the board and extending around the remaining section of the core.

A PCB trace section 1340 provides one (first) segment of an RF emissions pickup coil and connected to RF connector 910. A PCB trace section 1380 provides another (second) segment of an RF emissions pickup coil. A PCB trace section 1382 provides a further (third) segment of an RF emissions pickup coil. A PCB pad or via 1384A is used to solder and connect a wire 1390. A PCB pad or via 1384B is used to solder and connect other end of a wire 1390. The wire 1390 is illustrated as completing a loop of the winding. A PCB pad or via 1384C is used to solder and connect a wire 1392. A PCB pad or via 1384D is used to solder and connect other end of a wire 1392.

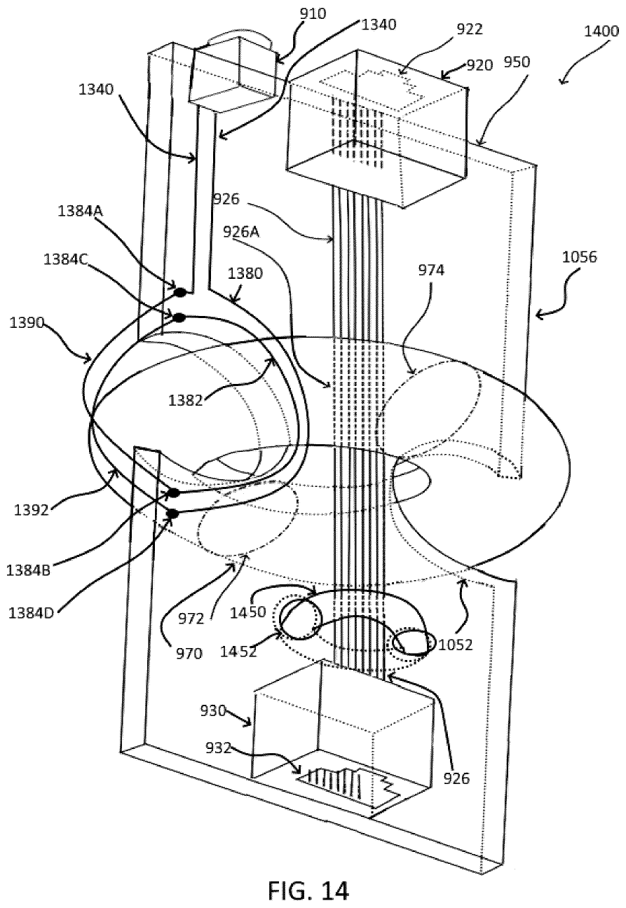

FIG. 14 illustrates a perspective view of an apparatus 1400 configured to capture emissions from a conductor of an electrical current. The apparatus 1400 is constructed essentially the same as the apparatus 1300, as described above in view of FIG. 13, except for an addition of a second ferrite core 1450, illustrated as a split core design and apertures 1452, where the second ferrite core 1450 functions as a filter. The second ferrite core 1450 may be configured as a low-pass filter to reduce or eliminate RF emissions entering the connector 930. In this way, only the RF emissions originating in the connector 920 are captured at the ferrite core 970. The normal communication through the conductors 926 is unaffected however. The second ferrite core 1450 may be used with any apparatus, as described in this document.

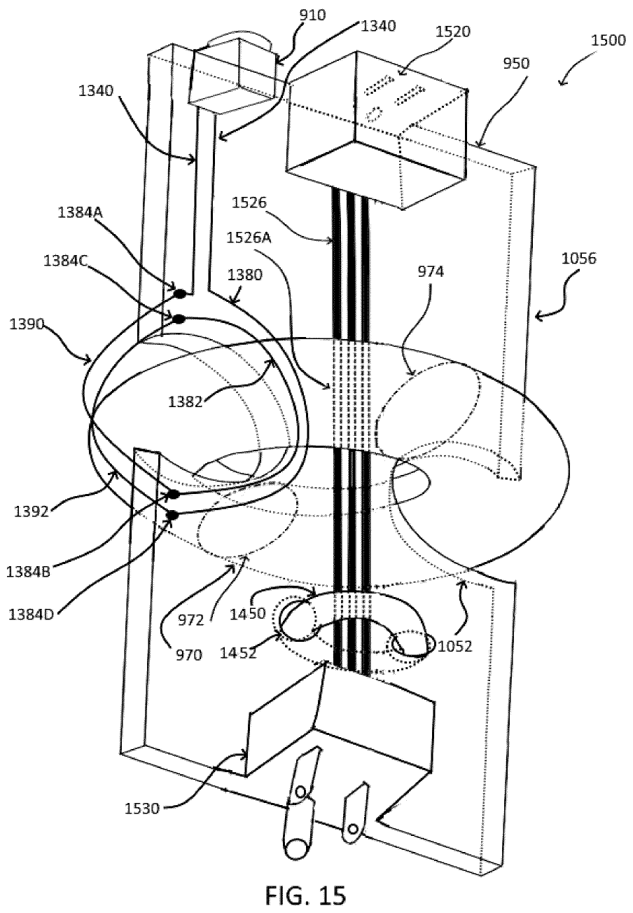

FIG. 15 illustrates a perspective view of an apparatus 1500 configured to capture emissions from a conductor of an electrical current. The apparatus 1500 is constructed essentially the same as the apparatus 1400, as described above in view of FIG. 14, except that RJ-45 connectors are replaced with a female power socket connector 1520 and male power connector 1530 and where the conductor is provided as a power (cord) wires 1526. The connectors 1520 and 1530 may be sized to handle a 120 volts of alternative current (VAC). AN aperture 1452 in the PCB 950 is shown to allow insertion of ferrite core 1450. The ferrite core 1450 may be a split ring hinged ferrite core or maybe two halves of a ferrite core glued or held together mechanically. Alternative means of performing low pass filtering or noise isolation may be employed in the circuit such as inductors, low pass filter circuits, etc. Conductor(s) 1526 may be sized to safely conduct current which may be typically 15 to 20 Amps.

FIG. 15 also illustrates an apparatus 1500 which may be inserted between an appliance power cord and a 120 VAC power outlet. The apparatus 1500 may contain an optional EMI filter ferrite core 1450 which reduces unneeded and unwanted electrical noise originating from the power outlet and the male power connector 1530. Thus, the RF connector 910 is configured to only receive emissions from the appliance powered and plugged into the female power socket connector 1520.

The apparatus 1500 may be used to extract emissions from an attached appliance. The emissions from the appliance may be used to determine or estimate appliance remaining useful life, predict or diagnose presence of degraded mechanical, electrical, or electromechanical components, or verify an estimated Economic value of the connected appliance.

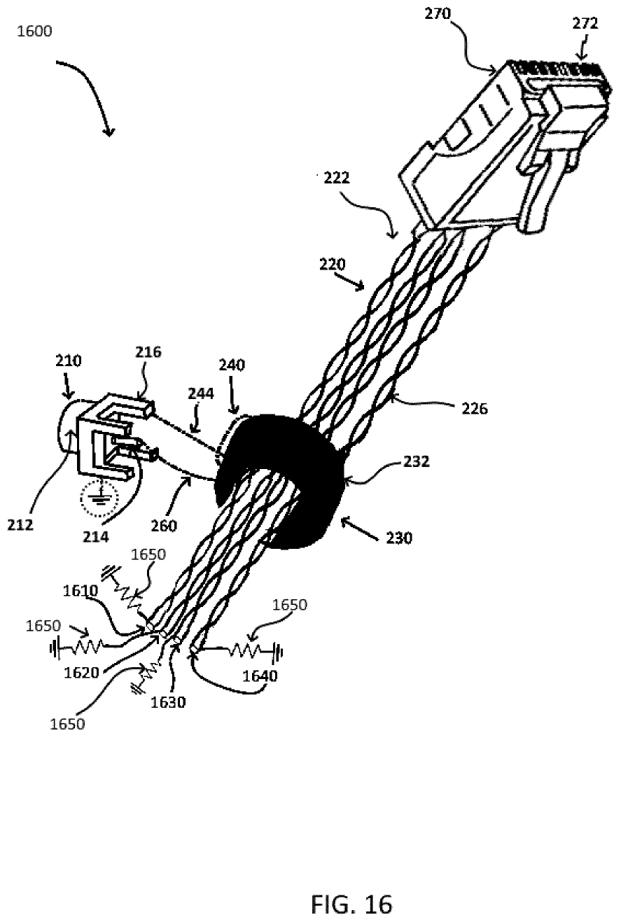

FIG. 16 illustrates a perspective view of an apparatus 1600 configured to capture emissions from a conductor of an electrical current. The apparatus 1600 is constructed essentially similar to the apparatus 200, as described above in view of FIG. 2, except that one connector is replaced with conductor's 1610, 1620, 1630, 1640, each for one pair of twisted wires and resistors 1650 to electrically ground each conductor, enabling common mode current acquisition. The RF ground may be used as a common ground.

It should be appreciated that reference throughout this specification to “one embodiment” or “an embodiment”, “exemplary embodiment” means that a particular feature, structure or characteristic described in connection with the embodiment is included in at least one embodiment of the disclosed subject matter. Therefore, it is emphasized and should be appreciated that two or more references to “an embodiment” or “one embodiment” or “exemplary embodiment” in various portions of this specification are not necessarily all referring to the same embodiment or the same variation. Furthermore, the particular features, structures or characteristics may be combined as suitable in one or more embodiments of the disclosed subject matter.

The chosen exemplary embodiments of the claimed subject matter have been described and illustrated for practical purposes so as to enable any person skilled in the art to which it pertains to make and use the same. It is therefore intended that all matters in the foregoing description and shown in the accompanying drawings be interpreted as illustrative and not in a limiting sense. It will be understood that variations, modifications, equivalents and substitutions for components of the specifically described exemplary embodiments of the subject matter may be made by those skilled in the art without departing from the spirit and scope of the subject matter as set forth in the appended claims.

Any element in a claim that does not explicitly state “means for” performing a specified function, or “step for” performing a specified function, is not to be interpreted as a “means” or “step” clause as specified in 35 U.S. C. sctn. 112, paragraph 6. In particular, any use of “step of” in the claims is not intended to invoke the provision of 35 U.S. C. sctn. 112, paragraph 6.

Furthermore, the Abstract is not intended to be limiting as to the scope of the claimed subject matter and is for the purpose of quickly determining the nature of the claimed subject matter.

1. An apparatus, comprising:
a conductor connector;
a conductor of electrical current, the conductor having one end thereof in an electrical signal connection and in a mechanical connection with the conductor connector;
a toroid including a core with an opening through a thickness of the core and a winding around the core, the conductor passing through the opening, the core being in a magnetic field connection with the conductor in a response to a current flow through the conductor; and
a radio frequency (RF) connector having a center pin in an electrical signal connection with one end of the winding and having a shield in an electrical signal connection with another end of the winding, the center pin carrying a voltage induced across the winding.

2. (canceled)

3. (canceled)

4. (canceled)

5. The apparatus of claim 1, wherein the conductor comprises at least one pair of insulated wires twisted together.

6. (canceled)

7. (canceled)

8. The apparatus of claim 1, wherein the conductor comprises a plurality of copper traces on a substrate.

9. (canceled)

10. (canceled)

11. The apparatus of claim 1, wherein the RF connector being any one of a subminiature version A (SMA), a subminiature version (SMB), a subminiature push-on (SMP), a bayonet neill-councelman (BNC), and an N-Type.

12. The apparatus of claim 1, wherein the winding comprises one and only one complete loop of a single electrical wire.

13. The apparatus of claim 1, wherein the winding comprises two and only two complete loops of a single electrical wire.

14. (canceled)

15. The apparatus of claim 1, further comprising another conductor connector in an electrical signal connection and in a mechanical connection with an opposite end of the conductor.

16. The apparatus of claim 1, further comprising at least one resistor in an electrical signal connection and in a mechanical connection with an opposite end of the conductor.

17. The apparatus of claim 1, further comprising an enclosure in mechanical connections with the conductor connector and the RF connector.

18. (canceled)

19. The apparatus of claim 1, further comprising a board sized to pass through the opening in the core and wherein the conductor being at least partially disposed on and/or within the board as at least one trace.

20. The apparatus of claim 1, further comprising a board with two apertures, wherein the conductor at least partially disposed on and/or within the board as at least one trace and wherein the core includes a hinged connection, the core being passed through the two apertures.

21. The apparatus of claim 1, further comprising a board with two cutouts in opposite edges, wherein the conductor being at least partially disposed on and/or within the board as at least one trace and wherein the core includes a hinged connection, the core being passed through the two cutouts.

22. The apparatus of claim 1, further comprising a board, wherein ends of the winding being at least partially disposed on and/or within the board as two traces.

23. An apparatus, consisting of:
an enclosure having a peripheral wall, the peripheral wall defining a hollow interior;
a first conductor connector being in a mechanical connection with the enclosure at a first aperture in a first portion of the peripheral wall;
a second conductor connector being in a mechanical connection with the enclosure at a second aperture in a second portion of the peripheral wall;
a conductor of an electrical current, the conductor disposed within the hollow interior, the conductor being in a first electrical signal connection at a first end thereof with one conductor connector from first and second conductor connectors and being in a second electrical signal connection and in a second mechanical connection, at an opposite second end thereof, with another conductor connector from the first and second conductor connectors;
a toroid including a core with a through opening encasing the conductor and a winding around the core; and
a radio frequency (RF) connector being in a mechanical connection with the enclosure at a third aperture in a third portion of the peripheral wall, the RF connector being in a first electrical signal connection and in a first mechanical connection with one end of the winding and being in a second electrical signal connection and in a second mechanical connection with another end of the winding;
wherein the apparatus being configured to capture at least one emission of an electromagnetic energy in RF spectrum range from the conductor, the electromagnetic energy being generated within a magnetic field in the winding in a response to an electrical current flow through the conductor, and output a voltage through the RF connector, the voltage induced across the winding, the voltage containing a signature of the at least one emission.

24. An apparatus, comprising:
an enclosure having a peripheral wall, the peripheral wall defining a hollow interior;
a first conductor connector being in a mechanical connection with the enclosure at a first aperture in a first portion of the peripheral wall;
a second conductor connector being in a mechanical connection with the enclosure at a second aperture in a second portion of the peripheral wall;
a conductor of an electrical current, the conductor disposed within the hollow interior, conductor being in a first electrical signal connection at a first end thereof with one conductor connector from first and second conductor connectors and being in a second electrical signal connection and in a second mechanical connection, at an opposite second end thereof, with another conductor connector from the first and second conductor connectors;
a toroid including a core with a through opening encasing the conductor and a winding around the core; and
a radio frequency (RF) connector being in a mechanical connection with the enclosure at a third aperture in a third portion of the peripheral wall, the RF connector being in a first electrical signal connection and in a first mechanical connection with one end of the winding and being in a second electrical signal connection and in a second mechanical connection with another end of the winding;
wherein the apparatus being configured to capture at least one emission of an electromagnetic energy in RF spectrum range from the conductor, the electromagnetic energy being generated within a magnetic field in the winding in a response to an electrical current flow through the conductor, and output a voltage through the RF connector, the voltage induced across the winding, the voltage containing a signature of the at least one emission.

25. The apparatus of claim 24, wherein the enclosure is an electrically conductive enclosure.

26. The apparatus of claim 24, wherein the enclosure is an electrically grounded enclosure.

27. (canceled)

28. (canceled)

29. The apparatus of claim 24, wherein the RF connector being any one of a subminiature version A (SMA), a subminiature version (SMB), a subminiature push-on (SMP), a bayonet neill-councelman (BNC), and an N-Type.

30. The apparatus of claim 24, wherein one of the first and second conductor connectors comprises a male RJ-45 connector.

31. The apparatus of claim 24, wherein one of the first and second conductor connectors comprises a female RJ-45 connector.

32.-43. (canceled)
